(19) United States
(12) Patent Application Publication
(10) Pub. No.: US 2026/0221096 A1
(43) Pub. Date: Jul. 30, 2026

(54) DISPLAY, DISPLAY DRIVER, AND ELECTRONIC DEVICE AND DRIVING METHOD THEREOF

(71) Applicant: HUAWEI TECHNOLOGIES CO., LTD., Shenzhen (CN)

(72) Inventors: Congbiao Jiang, Shenzhen (CN); Jun Liu, Shenzhen (CN); Yancan Min, Chengdu (CN); Pengfei Zhao, Shenzhen (CN)

(73) Assignees: HUAWEI TECHNOLOGIES CO., LTD., Shenzhen (CN); HUAWEI TECHNOLOGIES CO., LTD., Shenzhen (CN)

(21) Appl. No.: 19/578,225

(22) Filed: Mar. 25, 2026

Related U.S. Application Data
(63) Continuation of application No. PCT/CN2024/120486, filed on Sep. 23, 2024.

(30) Foreign Application Priority Data
Sep. 27, 2023 (CN) 202311261835.8

(51) Int. Cl. G09G 3/3233

(52) U.S. Cl. CPC G09G 3/3233; G09G 2300/0842; G09G 2300/0861; G09G 2310/08; G09G 2320/0233; G09G 2320/0247; G09G 2340/0435

(57) ABSTRACT

Embodiments of this application relate to the field of electronic technologies, and provide displays, display drivers, and electronic devices and driving methods thereof One example display includes N rows of pixels and a plurality of reset voltage ends. N is a positive integer, and each row of pixels includes a plurality of pixel circuits spaced from each other. Each reset voltage end is electrically connected to the N rows of pixels. At least one of the plurality of reset voltage ends is configured to: provide a first reset voltage in a first time period in an image frame, and provide a second reset voltage in a second time period in the image frame. A value of the first reset voltage is different from a value of the second reset voltage.

### CROSS-REFERENCE TO RELATED APPLICATIONS

This application is a continuation of International Application No. PCT/CN2024/120486, filed on Sep. 23, 2024, which claims priority to Chinese Patent Application No. 202311261835.8, filed on Sep. 27, 2023. The disclosures of the aforementioned applications are hereby incorporated by reference in their entireties.

### TECHNICAL FIELD

This application relates to the field of electronic technologies, and in particular, to a display, a display driver, and an electronic device and a driving method thereof.

### BACKGROUND

In recent years, as a demand for a screen-to-body ratio of a display of an electronic device gradually increases in an electronic device market, various display technologies such as a display area punching technology, a dual-curved waterfall screen technology, a quad-curved surface technology, and an under-screen camera technology, emerge. At present, the display area puncturing technology is a mainstream trend.

However, because some pixels need to be removed from a display area during display area punching, a load corresponding to a signal line in a punched area is different from that in a non-punched area. This affects pixel charging time, and further causes uneven display brightness of the display. However, different frame rates in different areas of the display, a reset voltage fluctuation, and the like also cause uneven display brightness of the display. This affects user experience.

### SUMMARY

Embodiments of this application provide a display, a display driver, and an electronic device and a driving method thereof, to resolve a problem of uneven display brightness of the display.

To achieve the foregoing objective, the following technical solutions are used in this application.

According to a first aspect of embodiments of this application, a display is provided, including N rows of pixels and a plurality of reset voltage ends. N is a positive integer, and each row of pixels includes a plurality of pixel circuits spaced from each other. Each reset voltage end is electrically connected to the N rows of pixels. At least one of the plurality of reset voltage ends is configured to: provide a first reset voltage for the pixel circuit in a first time period in one image frame, and provide a second reset voltage for the pixel circuit in a second time period in the image frame, where a value of the first reset voltage is different from a value of the second reset voltage.

In the display provided in this embodiment of this application, the reset voltage end provides the first reset voltage in the first time period in one image frame, and provides the second reset voltage in the second time period in the image frame. In addition, the value of the first reset voltage is different from the value of the second reset voltage. In this case, a first part of rows of pixels in the display receive the first reset voltage, and a second part of rows of pixels receive the second reset voltage. When the reset voltage is fixed, factors such as unfixed load, unfixed frame rate, and voltage fluctuation cause uneven display brightness. In this embodiment of this application, a variable reset voltage is provided for the N rows of pixel circuits in one image frame, to reversely compensate for impact caused by the unfixed load, the unfixed frame rate, and the voltage fluctuation, so as to resolve a problem of uneven display brightness. In addition, a value of the reset voltage may be dynamically adjusted based on a position of a pixel row in the display. A pixel row on which the first reset voltage is received and a pixel row on which the second reset voltage is received may be dynamically adjusted, and may be arranged according to any rule. An adjustment manner is dynamic, flexible, and applicable to a plurality of scenarios, and has a wide application range.

In a possible implementation, the plurality of reset voltage ends include a first reset voltage end. The pixel circuit includes a driving transistor and a first reset circuit. Two ends of the first reset circuit are electrically connected to a control electrode of the driving transistor and the first reset voltage end respectively. A drive current of the pixel circuit may be adjusted by adjusting a reset voltage of the first reset voltage end, to adjust light emitting brightness of the pixel circuit.

In a possible implementation, the plurality of reset voltage ends include a second reset voltage end. The pixel circuit includes a driving transistor and a second reset circuit. Two ends of the second reset circuit are electrically connected to a first electrode of the driving transistor and the second reset voltage end respectively. A drive current of the pixel circuit may be adjusted by adjusting a reset voltage of the second reset voltage end, to adjust light emitting brightness of the pixel circuit.

In a possible implementation, the plurality of reset voltage ends include a third reset voltage end. The pixel circuit includes a light emitting device and a third reset circuit. Two ends of the third reset circuit are electrically connected to an anode of the light emitting device and the third reset voltage end respectively. Light emitting duration of the pixel circuit may be adjusted by adjusting a reset voltage of the third reset voltage end, to adjust light emitting brightness of the pixel circuit.

In a possible implementation, a first part of the N rows of pixels is configured to receive the first reset voltage in the first time period, and a second part of the N rows of pixels is configured to receive the second reset voltage in the second time period. A pixel row on which the first reset voltage is received and a pixel row on which the second reset voltage is received may be dynamically adjusted, and may be arranged according to any rule. An adjustment manner is dynamic, flexible, and applicable to a plurality of scenarios, and has a wide application range.

In a possible implementation, the reset voltage end is configured to: provide the first reset voltage for a 1^{st} row to an M^{th} row of pixels, provide the second reset voltage for an (M+1)^{th} row to an I^{th} row of pixels, and provide the first reset voltage for an (I+1)^{th} row to an N^{th} row of pixels, where M<I<N. This is an adjustment scenario in which light emitting brightness of the (M+1)^{th} row to the I^{th} row of pixels is different from light emitting brightness of another row of pixels.

In a possible implementation, the reset voltage end is configured to: provide the first reset voltage for a 1^{st} row to an M^{th} row of pixels, provide the second reset voltage for an (M+1)^{th} row to an I^{th} row of pixels, provide the first reset voltage for an (I+1)^{th} row to an L^{th} row of pixels, provide the second reset voltage or a third reset voltage for an (L+1)^{th} row to a T^{th} row of pixels, and provide the first reset voltage for a (T+1)^{th} row to an N^{th} row of pixels, where M<IL<T<N. This is an adjustment scenario in which light emitting brightness of the (M+1)^{th} row to the I^{th} row of pixels and light emitting brightness of the (L+1)^{th} row to the T^{th}row are different from light emitting brightness of another row of pixels.

In a possible implementation, a value of the first reset voltage output by the first reset voltage end, a value of the first reset voltage output by the second reset voltage end, and a value of the first reset voltage output by the third reset voltage end are different. A value of the reset voltage end is related to a required value of a to-be-reset node, and may be dynamically and flexibly adjusted.

According to a second aspect of embodiments of this application, a display driver is provided, including: an image data receiving end, configured to receive image data; a processing circuit, configured to generate a first reset voltage and a second reset voltage based on the image data, where a value of the first reset voltage is different from a value of the second reset voltage; and a plurality of reset voltage output ends, where at least one of the reset voltage output ends is configured to: output the first reset voltage in a first time period in one image frame, and output the second reset voltage in a second time period in the image frame. Beneficial effects of the display driver provided in the second aspect of embodiments of this application are the same as beneficial effects of the display. Details are not described herein again.

In a possible implementation, the display driver further includes a temperature receiving end configured to receive temperature data. The processing circuit is further configured to generate the first reset voltage and the second reset voltage based on the temperature data. A temperature of the display affects component performance of a pixel circuit in the display. Therefore, a temperature of the display is also considered as a factor for adjusting a reset voltage value, so that uniformity of display brightness can be further improved.

In a possible implementation, the processing circuit includes: a voltage calculation module, configured to: receive the image data, and output a basic voltage and a compensation voltage; a voltage time sequence control module, configured to: receive the basic voltage, the compensation voltage, and a row signal, and output the first reset voltage or the second reset voltage and a trigger signal; and a voltage output module, configured to: receive the trigger signal, the first reset voltage, and the second reset voltage, and output the first reset voltage or the second reset voltage. This is an implementation with a simple structure.

In a possible implementation, the voltage calculation module is further configured to receive a frame rate signal. This is an application scenario of displaying at a high frame rate and a low frame rate.

In a possible implementation, the plurality of reset voltage output ends include a first reset voltage output end, a second reset voltage output end, and a third reset voltage output end. Values of the first reset voltage output by the first reset voltage output end, the first reset voltage output by the second reset voltage output end, and the first reset voltage output by the third reset voltage output end are different.

According to a third aspect of embodiments of this application, an electronic device is provided, including a display and a display driver. The display includes the display according to any one of the implementations of the first aspect. The display driver includes the display driver according to any one of the implementations of the second aspect. A reset voltage end of the display is electrically connected to a reset voltage output end of the display driver.

According to a fourth aspect of embodiments of this application, a driving method of an electronic device is provided, including: in one image frame, activating N rows of pixels of the display row by row; the reset voltage output end of the display driver outputs a first reset voltage to the display in a first time period, where a first part of the N rows of pixels receives the first reset voltage for reset; and the reset voltage output end outputs a second reset voltage to the display in a second time period, where a second part of the N rows of pixels receive the second reset voltage for reset, and a value of the first reset voltage is different from a value of the second reset voltage.

In a possible implementation, a 1^{st} row of pixels is activated, and the reset voltage output end outputs the first reset voltage to the display. An (M+1)^{th} row of pixels is activated, and the reset voltage output end outputs the second reset voltage to the display. An (I+1)^{th} row of pixels is activated, and the reset voltage output end outputs the first reset voltage to the display.

In a possible implementation, a 1^{st} row of pixels is activated, and the reset voltage output end outputs the first reset voltage to the display. An (M+1)^{th} row of pixels is activated, and the reset voltage output end outputs the second reset voltage to the display. An (I+1)^{th} row of pixels is activated, and the reset voltage output end outputs the second reset voltage or a third reset voltage to the display. An (L+1)^{th} row of pixels is activated, and the reset voltage output end outputs the first reset voltage to the display.

### BRIEF DESCRIPTION OF DRAWINGS

FIG. 1 is a diagram of a layout of an electronic device according to an embodiment of this application;

FIG. 2 is a diagram of a topology structure of a pixel circuit according to an embodiment of this application;

FIG. 3 is a diagram of a driving time sequence of a pixel circuit according to an embodiment of this application;

FIG. 4A is a diagram of a pulse of a reset voltage according to an embodiment of this application;

FIG. 4B is a diagram of a display effect of a display according to an embodiment of this application;

FIG. 4C is a diagram of trace arrangement of a display according to an embodiment of this application;

FIG. 4D is a diagram of refresh rate distribution of a display according to an embodiment of this application;

FIG. 5 is a diagram of a driving time sequence of a display according to an embodiment of this application;

FIG. 6 is a diagram of a pulse of a reset voltage of a first reset voltage end according to an embodiment of this application;

FIG. 7 is a diagram of a pulse of a reset voltage of a first reset voltage end according to an embodiment of this application;

FIG. 8 is a diagram of a pulse of a reset voltage of a third reset voltage end according to an embodiment of this application;

FIG. 9 is a diagram of a structure of a display driver according to an embodiment of this application; and

FIG. 10 is a diagram of a structure of another display driver according to an embodiment of this application.

### DESCRIPTION OF EMBODIMENTS

The following describes the technical solutions in embodiments of this application with reference to the accompanying drawings in embodiments of this application. It is clear that the described embodiments are merely a part rather than all of embodiments of this application.

Terms such as “second” and “first” below are only for ease of description, and cannot be understood as indicating or implying relative importance or implicitly indicating a quantity of indicated technical features. Therefore, a feature limited by “second”, “first”, or the like may explicitly or implicitly include one or more features. In the descriptions of this application, unless otherwise stated, “a plurality of” means two or more than two.

In embodiments of this application, orientation terms such as “upper”, “lower”, “left”, and “right” may include but are not limited to definitions based on illustrated orientations in which components in the accompanying drawings are placed. It should be understood that these directional terms may be relative concepts, are used for description and clarification of relative positions, and may vary accordingly depending on a change in the orientations in which the components in the accompanying drawings are placed in the accompanying drawings.

In embodiments of this application, unless otherwise clearly specified and limited, the term “connection” should be understood in a broad sense. For example, the “connection” may be a fixed connection, a detachable connection, or an integrated connection, or may be a direct connection or an indirect connection implemented through an intermediate medium. In addition, the term “electrical connection” may be a direct electrical connection or an indirect electrical connection through an intermediate medium. The term “contact” may be direct contact or indirect contact through an intermediate medium.

In embodiments of this application, “and/or” describes an association relationship between associated objects, and indicates that three relationships may exist. For example, A and/or B may indicate the following cases: Only A exists, both A and B exist, and only B exists, where A and B may be singular or plural. The character “/” usually indicates an “or” relationship between the associated objects.

Embodiments of this application provide an electronic device. The electronic device is, for example, a consumer electronic product, a home electronic product, a vehicle-mounted electronic product, or a financial electronic device product that has a display function. The consumer electronic product is, for example, a mobile phone (mobile phone), a tablet computer (pad), a notebook computer, an e-reader, a personal computer (personal computer, PC), a personal digital assistant (personal digital assistant, PDA), a desktop display, an intelligent wearable product (for example, a smartwatch or a smart band), a virtual reality (virtual reality, VR) electronic device, an augmented reality (augmented reality, AR) electronic device, or an uncrewed aerial vehicle. The home electronic product is, for example, a smart door lock, a television, a remote control, a refrigerator, a small household charging appliance (for example, a soy milk maker or a robot vacuum), or the like. The vehicle-mounted electronic product is, for example, a vehicle-mounted navigator or a vehicle-mounted high-density digital video disc (digital video disc, DVD). The financial electronic device product is, for example, an automated teller machine (automated teller machine, ATM) or an electronic device for self-help services. A specific form of the electronic device is not specially limited in embodiments of this application.

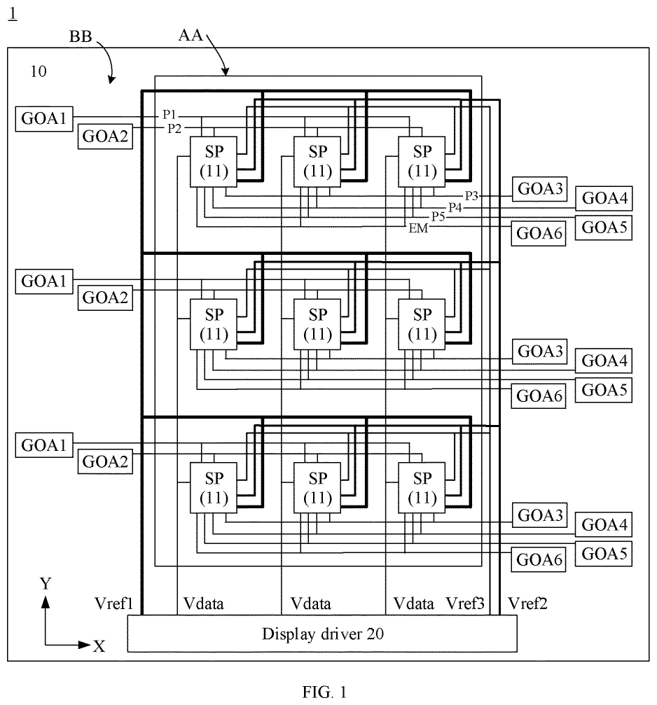

For example, the electronic device is a mobile phone. As shown in FIG. 1, the electronic device 1 includes a display 10 and a display driver 20. FIG. 1 shows an example in which the electronic device 1 is a straight-screen mobile phone. This embodiment of this application is merely an example.

In some embodiments, the display 10 may be a display that can implement self-luminance, for example, an organic light emitting diode (organic light emitting diode, OLED) display, a micro organic light emitting diode (micro OLED) display, or a quantum dot light emitting diode (quantum dot light emitting diodes, QLED) display.

For any type of the foregoing displays 10, the display 10 includes an active area (active area, AA) and a non-display area BB around the active area AA. The active area AA is configured to display an image, and the active area AA includes a plurality of sub-pixels (sub-pixel, SP). For example, the plurality of sub-pixels SPs are arranged in a matrix form in a plurality of rows and a plurality of columns. For example, sub-pixels SPs arranged in a row in a horizontal direction X are referred to as a row of sub-pixels SPs, and sub-pixels SPs arranged in a column in a vertical direction Y are referred to as a column of sub-pixels SPs. A pixel circuit is disposed in each sub-pixel SP, and a plurality of pixel circuits are disposed in the active area AA of the display 10. The plurality of pixel circuits are arranged in a plurality of rows and a plurality of columns. In this embodiment of this application, the horizontal direction X is a direction intersecting a data line in the display 10, and the vertical direction Y is a direction parallel to the data line in the display 10. The data line is a signal line configured to transmit a data voltage to the pixel circuit in the display 10.

The display driver 20 is configured to provide, for the pixel circuit in the display 10, a control signal, a reset voltage, a data signal, and the like that are required for light emission. The following describes, with reference to a structure of the pixel circuit, a signal sent by the display driver 20. The display driver 20 is, for example, a display driver integrated circuit (display driver integrated circuit, DDIC).

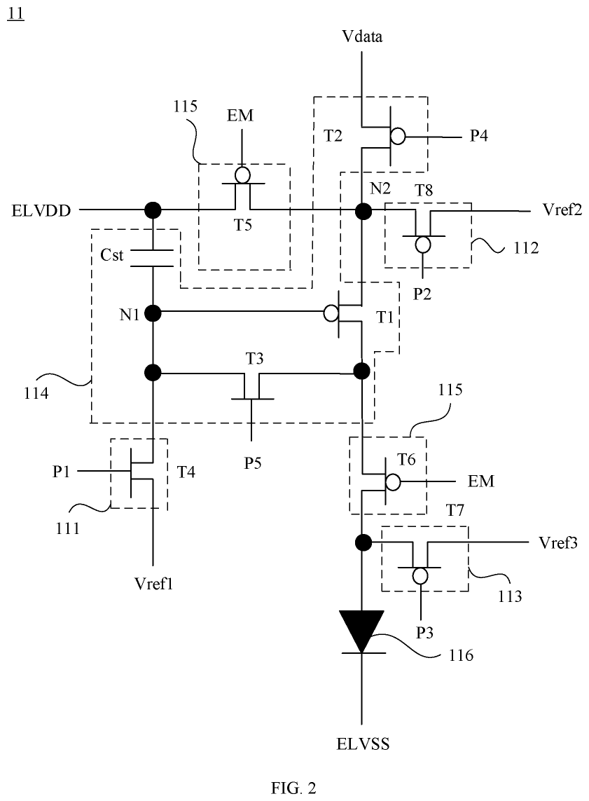

FIG. 2 is a diagram of a topology structure of a pixel circuit according to an embodiment of this application.

An active matrix organic light emitting diode (active matrix organic light emitting diode, AMOLED) display using a self-light-emitting display technology has a flexible form that is bendable and foldable, has advantages such as a high contrast, a wide color gamut, a wide viewing angle, and a wide operating temperature, and is widely used on displays of a television, a notebook computer, a mobile phone, and the like.

The AMOLED is used as an example. In some embodiments, as shown in FIG. 2, a pixel circuit 11 usually includes a drive circuit including a plurality of transistors and a light emitting device. The drive circuit generates a drive current to drive the light emitting device to emit light. In this way, light emission of the pixel circuit 11 is implemented.

For example, the pixel circuit 11 includes a first reset circuit 111, a second reset circuit 112, a third reset circuit 113, a writing and threshold compensation circuit 114, a light emission control circuit 115, and a light emitting device 116. The pixel circuit 11 shown in FIG. 2 is merely an example, and constitutes no limitation.

The first reset circuit 111 is electrically connected to a first reset voltage end Vref1, a first control signal end P1, and a first node N1, and is configured to transmit a reset voltage of the first reset voltage end Vrefl to the first node N1 under control of a first control signal of the first control signal end P1, to reset (or initialize) the first node N1.

The second reset circuit 112 is electrically connected to a second reset voltage end Vref2, a second control signal end P2, and a second node N2, and is configured to transmit a reset voltage of the second reset voltage end Vref2 to the second node N2 under control of a second control signal of the second control signal end P2, to reset (or initialize) the second node N2.

The third reset circuit 113 is electrically connected to a third reset voltage end Vref3, a third control signal end P3, and an anode of the light emitting device 116, and is configured to transmit a reset voltage of the third reset voltage end Vref3 to the anode of the light emitting device 116 under control of a third control signal of the third control signal end P3, to reset (or initialize) the anode of the light emitting device 116.

The writing and threshold compensation circuit 114 is electrically connected to a fourth control signal end P4, a fifth control signal end P5, the second node N2, a first power voltage end ELVDD, and a data voltage end Vdata, and is configured to transmit a data voltage of the data voltage end Vdata to the writing and threshold compensation circuit 114 under control of a fourth control signal of the fourth control signal end P4 and a fifth control signal of the fifth control signal end P5, to perform data writing and threshold compensation.

The light emission control circuit 115 is electrically connected to a light emission control signal end (emission, EM), the first power voltage end ELVDD, the writing and threshold compensation circuit 114, and the light emitting device 116, and is configured to provide a drive current for the light emitting device 116 under control of a light emission control signal provided by the light emission control signal end EM.

The light emitting device 116 is electrically connected to a second power voltage end ELVSS, and is configured to emit light under drive of the drive current.

In this embodiment of this application, an example in which the first power voltage end ELVDD is a high-level power voltage end and the second power voltage end ELVSS is a low-level power voltage end is used for illustration. However, this is not limited.

Still refer to FIG. 2. In some embodiments, the writing and threshold compensation circuit 114 includes a driving transistor (driving thin film transistor, DTFT) T1. A control electrode (for example, a gate) of the driving transistor T1 is electrically connected to the first node N1 (namely, the first reset circuit 111), and a first electrode (for example, a source or a drain) of the driving transistor T1 is electrically connected to the second node N2 (namely, the second reset circuit 112).

Further, the writing and threshold compensation circuit 114 further includes a second transistor T2, a third transistor T3, and a storage capacitor Cst. The first reset circuit 111 includes a fourth transistor T4. The second reset circuit 112 includes an eighth transistor T8. The third reset circuit 113 includes a seventh transistor T7. The light emission control circuit 115 includes a fifth transistor T5 and a sixth transistor T6.

The second transistor T2, the third transistor T3, the fourth transistor T4, the fifth transistor T5, the sixth transistor T6, the seventh transistor T7, and the eighth transistor T8 are switch transistors. The light emitting device 116 is, for example, an OLED, a micro OLED, or a QLED.

In the following descriptions, a control electrode of a transistor may be, for example, a gate of the transistor, and a first electrode of the transistor and a second electrode of the transistor are respectively a source and a drain of the transistor. This is explained herein, and is not explained again below.

The control electrode of the driving transistor T1 is electrically connected to the first node N1, the first electrode of the driving transistor T1 is electrically connected to the second node N2, and a second electrode of the driving transistor T1 is electrically connected to a first electrode of the third transistor T3.

A control electrode of the second transistor T2 is electrically connected to the fourth control signal end P4, a first electrode of the second transistor T2 is electrically connected to the data voltage end Vdata, and a second electrode of the second transistor T2 is electrically connected to the second node N2.

A control electrode of the third transistor T3 is electrically connected to the fifth control signal end P5, and a second electrode of the third transistor T3 is electrically connected to the first node N1.

One end of the storage capacitor Cst is electrically connected to the first node N1, and the other end of the storage capacitor Cst is coupled to the first power voltage end ELVDD.

A control electrode of the fourth transistor T4 is electrically connected to the first control signal end P1, a first electrode of the fourth transistor T4 is electrically connected to the first reset voltage end Vref1, and a second electrode of the fourth transistor T4 is electrically connected to the first node N1.

A control electrode of the seventh transistor T7 is electrically connected to the third control signal end P3, a first electrode of the seventh transistor T7 is electrically connected to the third reset voltage end Vref3, and a second electrode of the seventh transistor T7 is electrically connected to the anode of the light emitting device 116.

A control electrode of the eighth transistor T8 is electrically connected to the second control signal end P2, a first electrode of the eighth transistor T8 is electrically connected to the second reset voltage end Vref2, and a second electrode of the eighth transistor T8 is electrically connected to the second node N2.

A control electrode of the fifth transistor T5 is electrically connected to the light emission control signal end EM, a first electrode of the fifth transistor T5 is electrically connected to the first power voltage end ELVDD, and a second electrode of the fifth transistor T5 is electrically connected to the second node N2.

A control electrode of the sixth transistor T6 is electrically connected to the light emission control signal end EM, a first electrode of the sixth transistor T6 is electrically connected to the second electrode of the driving transistor T1, and a second electrode of the sixth transistor T6 is electrically connected to the anode of the light emitting device 116.

For example, in the pixel circuit 11, the third transistor T3 and the fourth transistor T4 are oxide thin film transistors (oxide thin film transistor, Oxide TFT), are N-type transistors, and are turned on under control of a high-level signal. Alternatively, the third transistor T3 and the fourth transistor T4 may be transistors of other types. This is not limited in embodiments of this application. The driving transistor T1, the second transistor T2, the fifth transistor T5, the sixth transistor T6, the seventh transistor T7, and the eighth transistor T8 are low temperature polysilicon thin film transistors (low temperature polysilicon thin film transistor, LTPS TFT), are P-type transistors, and are turned on under control of a low-level signal. Alternatively, the driving transistor T1, the second transistor T2, the fifth transistor T5, the sixth transistor T6, the seventh transistor T7, and the eighth transistor T8 may be transistors of other types. This is not limited in embodiments of this application.

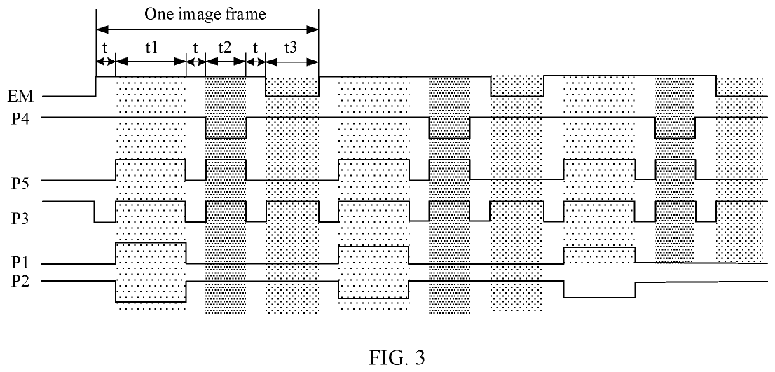

FIG. 3 is a diagram of a driving time sequence of a pixel circuit according to an embodiment of this application.

With reference to FIG. 2 and FIG. 3, a light emitting process of the pixel circuit 11 in one image frame may be divided into an initialization phase tl, a data writing and compensation phase t2, a light emitting phase t3, and an anode reset phase t.

In the initialization phase t1:

The first control signal of the first control signal end P1 changes from a low level to a high level, and then changes from the high level to the low level. Therefore, the fourth transistor T4 changes from being turned off to being turned on, and then changes from being turned on to being turned off. The second control signal of the second control signal end P2 changes from a high level to a low level, and then changes from the low level to the high level. Therefore, the eighth transistor T8 changes from being turned off to being turned on, and then changes from being turned on to being turned off.

A fifth control signal of the fifth control signal end P5 remains at a low level, the fourth control signal of the fourth control signal end P4 and the light emission control signal of the light emission control signal end EM each remain at a high level. Therefore, the seventh transistor T7, the second transistor T2, the third transistor T3, the fifth transistor T5, and the sixth transistor T6 each remain in an off state.

In the initialization phase t1, the fourth transistor T4 is turned on, so that voltage control of the first node N1 is implemented. Because the fourth transistor T4 is electrically connected to the control electrode of the driving transistor T1, in the initialization phase tl, voltage control of the control electrode of the driving transistor T1 and voltage control of one end of the storage capacitor Cst are implemented, so that a voltage of the control electrode of the driving transistor T1 and a voltage of the one end of the storage capacitor Cst are respectively reset voltages of the first reset voltage end Vref1. In other words, the voltage of the control electrode of the driving transistor T1 and the voltage of the one end of the storage capacitor Cst are separately reset.

In addition, the eighth transistor T8 is turned on, so that voltage control of the second node N2 is implemented. Because the eighth transistor T8 is electrically connected to the first electrode of the driving transistor T1, in the initialization phase t1, voltage control of the first electrode of the driving transistor T1 is implemented, so that a voltage of the first electrode of the driving transistor T1 is a reset voltage of the second reset voltage end Vref2. In other words, the voltage of the first electrode of the driving transistor T1 is reset, to adjust a threshold voltage of the driving transistor T1.

In the data writing and compensation phase t2:

The fourth control signal of the fourth control signal end P4 changes from a high level to a low level, and then changes from the low level to the high level. Therefore, the second transistor T2 changes from being turned off to being turned on, and then changes from being turned on to being turned off. The fifth control signal of the fifth control signal end P5 changes from a low level to a high level, and then changes from the high level to the low level. Therefore, the third transistor T3 changes from being turned off to being turned on, and then changes from being turned on to being turned off.

The second control signal of the second control signal end P2, the third control signal of the third control signal end P3, and the light emission control signal of the light emission control signal end EM each remain at the high level, and the first control signal of the first control signal end P1 remains at the low level. Therefore, the seventh transistor T7, the eighth transistor T8, the fifth transistor T5, the sixth transistor T6, and the fourth transistor T4 each remain in the off state.

In the data writing and compensation phase t2, the transistor T2, the transistor T3, and the transistor T1 are separately turned on, so that the data voltage of the data voltage end Vdata is stored in the storage capacitor Cst, and writing of the data voltage is completed. In addition, compensation is implemented on the threshold voltage of the driving transistor T1. A process of compensating for the threshold voltage of the driving transistor T1 may be considered as a process in which the driving transistor T1 changes from an on state to the off state.

In the light emitting phase t3:

The light emission control signal changes from a high level to a low level, and then changes from the low level to the high level. Therefore, the sixth transistor T6 and the fifth transistor T5 change from being turned off to being turned on, and then changes from being turned on to being turned off.

The first control signal of the first control signal end P1 and the fifth control signal of the fifth control signal end P5 remain at the low level, and the fourth transistor T4 and the third transistor T3 each remain in the off state. The second control signal of the second control signal end P2, the third control signal of the third control signal end P3, and the fourth control signal of the fourth control signal end P4 each remain at the high level, and the seventh transistor T7, the eighth transistor T8, and the second transistor T2 each remain in the off state.

In the light emitting phase t3, the fifth transistor T5, the driving transistor T1, and the sixth transistor T6 are separately turned on, to transmit the drive current to the light emitting device 116, and the light emitting device 116 emits light under driving of the drive current.

In the anode reset phase t:

The third control signal of the third control signal end P3 changes from the high level to a low level, and then changes from the low level to the high level. Therefore, the seventh transistor T7 changes from being turned off to being turned on, and then changes from being turned on to being turned off.

The first control signal of the first control signal end P1 and the fifth control signal of the fifth control signal end P5 remain at the low level, and the second control signal of the second control signal end P2, the fourth control signal of the fourth control signal end P4, and the light emission control signal of the light emission control signal end EM remain at the high level. The third transistor T3, the fourth transistor T4, the second transistor T2, the fifth transistor T5, the sixth transistor T6, and the eighth transistor T8 each remain in the off state.

In the anode reset phase t, the seventh transistor T7 is turned on, to control a voltage of the anode of the light emitting device 116, so that the voltage of the anode of the light emitting device 116 is a reset voltage of the third reset voltage end Vref3. In other words, the voltage of the anode of the light emitting device 116 is reset.

In one image frame, the anode reset phase t may be performed once before each of the initialization phase t1, the data writing and compensation phase t2, and the light emitting phase t3. Alternatively, anode reset may be performed once before one or two of the initialization phase t1, the data writing and compensation phase t2, and the light emitting phase t3. In the diagram of driving time sequence shown in FIG. 3, an example in which anode reset is performed once before each of the initialization phase t1, the data writing and compensation phase t2, and the light emitting phase t3 is used for illustration.

A plurality of rows of pixel circuits 11 work in a row-by-row refresh manner. To be specific, after a 1^{st} row of pixel circuits 11 complete the phases such as the initialization phase t1, the data writing and compensation phase t2, the light emitting phase t3, and the anode reset phase t, a 2^{nd} row of pixel circuits 11 enter the phases such as the initialization phase t1, the data writing and compensation phase t2, the light emitting phase t3, and the anode reset phase t, and then each subsequent row of pixel circuits 11 repeat the phases such as the initialization phase t1, the data writing and compensation phase t2, the light emitting phase t3, and the anode reset phase t. The rest may be deduced by analogy. Refresh is performed from top to bottom row by row.

The following describes, as examples, sources of the control signals received by the first control signal end P1, the second control signal end P2, the third control signal end P3, the fourth control signal end P4, the fifth control signal end P5, the light emission control signal end EM, the reset voltages received by the first reset voltage end Vref1, the second reset voltage end Vref2, and the third reset voltage end Vref3, and the data voltage received by the data voltage end Vdata in the pixel circuit 11.

As shown in FIG. 1, in some embodiments, the display 10 further includes a plurality of first gates on array (gate on array) GOA1. Each first gate on array GOAL is configured to provide first control signals for first control signal ends P1 of one row of pixel circuits 11. Certainly, each first gate on array GOA1 may alternatively provide first control signals for first control signal ends P1 of some pixel circuits 11 in one row of pixel circuits 11. Each row of pixel circuits 11 may correspond to a plurality of first gates on array GOA1.

For example, the plurality of first gates on array GOA1 are cascaded. A first-level first gate on array GOA1 receives a first start control signal, and outputs first control signals to 1^{st} row of first control signal ends P1. From a second-level first gate on array GOA 1, a first gate on array GOA 1 at each level receives a first control signal output by a first gate on array GOA1 at a previous level, and outputs the first control signal to a first control signal end P1 coupled to a first gate on array GOA1 at a current level, to provide first control signals for first control signal ends P1 of the plurality of rows of pixel circuits 11 row by row.

As shown in FIG. 1, in some embodiments, the display 10 further includes a plurality of second gates on array GOA2. Each second gate on array GOA2 is configured to provide second control signals for second control signal ends P2 of one row of pixel circuits 11. Certainly, each second gate on array GOA2 may alternatively provide second control signals for second control signal ends P2 of some pixel circuits 11 in one row of pixel circuits 11. Each row of pixel circuits 11 may correspond to a plurality of second gates on array GOA2.

In some embodiments, the display 10 further includes a plurality of third gates on array GOA3. Each third gate on array GOA3 is configured to provide third control signals for third control signal ends P3 of one row of pixel circuits 11. Certainly, each third gate on array GOA3 may alternatively provide third control signals for third control signal ends P3 of some pixel circuits 11 in one row of pixel circuits 11. Each row of pixel circuits 11 may correspond to a plurality of third gates on array GOA3.

In some embodiments, the display 10 further includes a plurality of fourth gates on array GOA4. Each fourth gate on array GOA4 is configured to provide fourth control signals for fourth control signal ends P4 of one row of pixel circuits 11. Certainly, each fourth gate on array GOA4 may alternatively provide fourth control signals for fourth control signal ends P4 of some pixel circuits 11 in one row of pixel circuits 11. Each row of pixel circuits 11 may correspond to a plurality of fourth gates on array GOA4.

In some embodiments, the display 10 further includes a plurality of fifth gates on array GOA5. Each fifth gate on array GOA5 is configured to provide fifth control signals for fifth control signal ends P5 of one row of pixel circuits 11. Certainly, each fifth gate on array GOA5 may alternatively provide fifth control signals for fifth control signal ends P5 of some pixel circuits 11 in one row of pixel circuits 11. Each row of pixel circuits 11 may correspond to a plurality of fifth gates on array GOA5.

In some embodiments, the display 10 further includes a plurality of sixth gates on array GOA6. Each sixth gate on array GOA6 is configured to provide light emission control signals for light emission control signal ends EM of one row of pixel circuits 11. Certainly, each sixth gate on array GOA6 may alternatively provide light emission control signals for light emission control signal ends EM of some pixel circuits 11 in one row of pixel circuits 11. Each row of pixel circuits 11 may correspond to a plurality of sixth gates on array GOA6.

Through pulling high and pulling low of the first gate on array GOA1, the second gate on array GOA2, the third gate on array GOA3, the fourth gate on array GOA4, the fifth gate on array GOA5, and the sixth gate on array GOA6 in different time periods, the plurality of rows of pixel circuits 11 sequentially enter the initialization phase t1, the data writing and compensation phase t2, the light emitting phase t3, and the anode reset phase t.

It should be understood that the first gate on array GOA1, the second gate on array GOA2, the third gate on array GOA3, the fourth gate on array GOA4, the fifth gate on array GOA5, and the sixth gate on array GOA6 shown in FIG. 1 are distributed on two sides of the plurality of rows of pixel circuits 11 in a row direction to generate control signals. Disposing positions of the first gate on array GOA1, the second gate on array GOA2, the third gate on array GOA3, the fourth gate on array GOA4, the fifth gate on array GOA5, and the sixth gate on array GOA6 in the display 10 in FIG. 1 are merely examples, and constitute no limitation.

The display 10 includes a plurality of data voltage ends Vdata, and pixel circuits 11 located in a same column are coupled to a same data voltage end Vdata. The display driver 20 is coupled to the plurality of data voltage ends Vdata, and is configured to provide a data voltage for each of the plurality of data voltage ends Vdata.

The display 10 further includes a plurality of reset voltage ends. Refer to FIG. 2. In this embodiment of this application, an example in which the display includes the first reset voltage end Vref1, the second reset voltage end Vref2, and the third reset voltage end Vref3 is used for illustration. The display driver 20 is coupled to the first reset voltage end Vref1, the second reset voltage end Vref2, and the third reset voltage end Vref3, and is configured to provide reset voltages for the first reset voltage end Vref1, the second reset voltage end Vref2, and the third reset voltage end Vref3. The first reset voltage end Vref1, the second reset voltage end Vref2, and the third reset voltage end Vref3 are separately coupled to the plurality of rows of pixel circuits 11 in the display 10.

To improve a display effect, a reset voltage is usually used in the pixel circuit 11, to improve stability of voltages of some nodes in the pixel circuit 11. For example, in the pixel circuit 11 shown in FIG. 2, the first reset voltage end Vref1, the second reset voltage end Vref2, and the third reset voltage end Vref3 provide reset voltages for the first node N1, the second node N2, and the anode of the light emitting device 116 in the pixel circuit 11. The first reset voltage end Vrefl resets and initializes the storage capacitor Cst, the second reset voltage end Vref2 resets and initializes the source (or the drain) of the driving transistor T1, and the third reset voltage end Vref3 resets and initializes the anode of the light emitting device 116.

The reset voltages of the first reset voltage end Vrefl, the second reset voltage end Vref2, and the third reset voltage end Vref3 are provided by the display driver 20 (DDIC). In addition, in scanning processes of all rows of pixel circuits 11, the reset voltages of the first reset voltage end Vref1, the second reset voltage end Vref2, and the third reset voltage end Vref3 are always fixed. Therefore, when a vertical blanking interval is found through row-by-row scanning by using a scanning signal, because the vertical blanking region is actually not coupled to the pixel circuit 11, loads coupled to the first reset voltage end Vrefl, the second reset voltage end Vref2, and the third reset voltage end Vref3 as power supply sources are decreased. This causes reset voltage fluctuations of the first reset voltage end Vref1, the second reset voltage end Vref2, and the third reset voltage end Vref3 in a high-load scenario and a low-load scenario. As a result, reset voltages of a specific row of pixel circuits 11 are different (reset states are different), display brightness is different, and a horizontal bright band or dark band appears on the display 10.

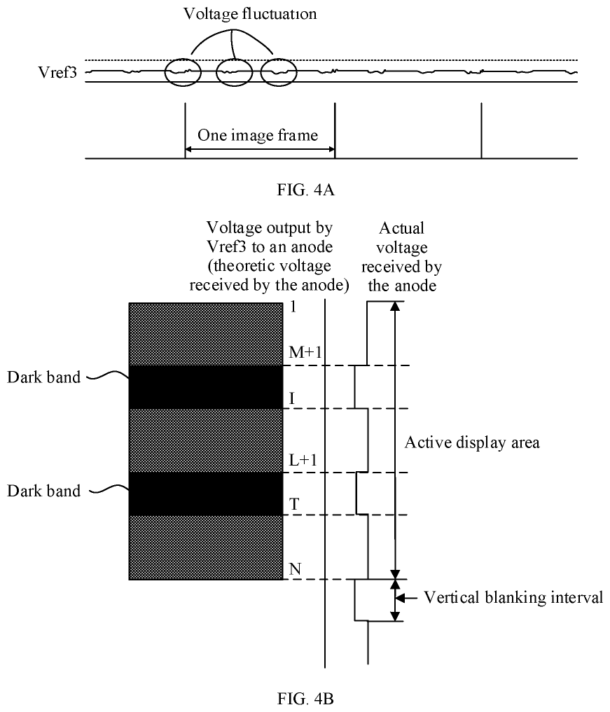

FIG. 4A is a diagram of a pulse of a reset voltage according to an embodiment of this application. FIG. 4B is a diagram of a display effect of the display according to an embodiment of this application.

For example, the driving time sequence shown in FIG. 3 is used as an example. In one image frame, the anode reset phase t is executed three times. As shown in FIG. 4A, in one image frame, in a process in which the third reset circuit 113 is turned on and turned off three times for reset, the third reset voltage end Vref3 resets the pixel circuit 11 three times. As a result, there are three voltage fluctuations at the third reset voltage end Vref3. However, because there is a vertical blanking interval (V blank) on the display 10, as shown in FIG. 4B, due to the voltage fluctuations, two dark bands appear during displaying. Display brightness of an (M+1)^{th} row to an I^{th} row of pixel circuits 11 is relatively low, and display brightness of an (L+1)^{th} row to a T^{th} row of pixel circuits 11 is relatively low.

FIG. 4C is a diagram of trace arrangement of the display according to an embodiment of this application.

In addition, as shown in FIG. 4C, due to a specific appearance design of the display 10, for example, a hole-punch screen, a notch screen, a multi-hole screen, or a pill (pill) screen, a trace coupled to the gate on array in a special design area is different from that in another area. A trace coupled to the first gate on array GOA1 is used as an example. The trace in the special area needs to bypass the special area. As a result, a trace in a row corresponding to the special area is longer and has a larger load than a trace in a normal area. This affects charging time of the pixel circuit 11. For example, in FIG. 4C, a trace in an (M+1)^{th} row bypasses the special area from above, a trace in an I^{th} row bypasses the special area from below, and traces corresponding to the (M+1)^{th} row to the I^{th} row of pixel circuits 11 are longer and have larger loads than the trace in the normal area. Consequently, display brightness of the (M+1)^{th} row to the I^{th} row of pixel circuits 11 is different from display brightness of another pixel circuit 11 in the display 10. As a result, a significant horizontal bright band or dark band, or understood as mura (mura) in the special area, appears during low-brightness and low-gray-scale displaying.

FIG. 4D is a diagram of area-based displaying of the display 10 according to an embodiment of this application.

In addition, as shown in FIG. 4D, with development of display technologies, the display 10 may have a requirement for displaying at a plurality of frame rates in different areas, that is, has a multi-frequency display scenario. In the multi-frequency display scenario, there are a plurality of refresh rates during displaying on a same screen. For example, in FIG. 4D, a middle area with a specific width has a high refresh rate, and an upper area and a lower area have low refresh rates. Because there are a plurality of different refresh rates on the display 10 at a same moment, and brightness varies between different refresh rates, brightness of two areas may be different during displaying at a high refresh rate and displaying at a low refresh rate. In this case, the display 10 has a significant display boundary at a boundary between different frame rates, in other words, display brightness is uneven.

Therefore, as display application scenarios continuously increase, uneven display brightness of the display 10 is significant, affecting user experience.

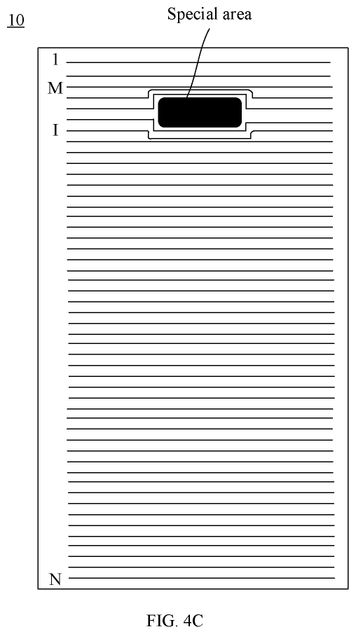

FIG. 5 is a diagram of a time sequence of the display according to an embodiment of this application.

To improve display uniformity of the display 10, in some embodiments, as shown in FIG. 5, a solution of dynamically adjusting a bias voltage Vbias and a reset voltage Vref is designed, to resolve a flicker problem during displaying at a low frame rate. During displaying at a low frame rate, because brightness changes due to voltage drift of the driving transistor T1 of the pixel circuit 11, flicker is perceived subjectively. Therefore, the bias voltage Vbias and the reset voltage Vref are adjusted at the beginning of some or all frames, to compensate for a brightness difference between different frames by using a voltage.

However, this manner can compensate for only brightness difference between different frames during displaying at a low frame rate, and has no improvement effect on a brightness difference during displaying at a high frame rate and a bright band or dark band in a same frame.

In view of this, an embodiment of this application further provides a row-level voltage adjustment solution. To be specific, the reset voltage of the pixel circuit 11 may be adjusted based on a quantity of display rows (or a display position) in one image frame to compensate for display brightness, so as to resolve a problem of horizontal brightness unevenness (a horizontal bright band or dark band) caused by a brightness difference between a high frame rate area and a low frame rate area during multi-frequency displaying, uneven display brightness of areas of the punch-hole screen, a load change, and the like in a displaying process of the display 10.

An embodiment of this application provides a display 10. The display 10 includes N rows of pixels, and each row of pixels includes a plurality of pixel circuits 11 spaced from each other. For how the pixel circuits 11 are arranged, refer to FIG. 1. For a structure of the pixel circuit 11, refer to FIG. 2. N is a positive integer. A value of N is not limited in embodiments of this application, and may be determined with reference to a shape of the display 10. Certainly, the value of the quantity N of rows in the display 10 may be greater than a quantity of pixel circuits 11 included in each row of pixels (namely, a quantity of columns in the display 10), or the value of the quantity N of rows in the display 10 may be less than or equal to a quantity of pixel circuits 11 included in each row of pixels (namely, a quantity of columns in the display 10).

The display 10 further includes a plurality of reset voltage ends, and each reset voltage end is electrically connected to all the N rows of pixels. In other words, each reset voltage end is coupled to all the pixel circuits 11 in the display 10.

At least one of the plurality of reset voltage ends is configured to: provide a first reset voltage for the pixel circuit in a first time period in one image frame, and provide a second reset voltage for the pixel circuit in a second time period in the image frame, where a value of the first reset voltage is different from a value of the second reset voltage.

In other words, in one image frame, a same reset voltage end provides the first reset voltage for the display 10 in the first time period. However, in the second time period, the reset voltage end provides the second reset voltage for the display 10. A reset voltage provided by the same reset voltage end is variable. In this case, reset voltages received by same ports (for example, the first reset voltage end Vref1) of different rows of pixel circuits 11 are accordingly different. A first part of the N rows of pixels is configured to receive the first reset voltage in the first time period, and a second part of the N rows of pixels is configured to receive the second reset voltage in the second time period. A sum of the first part and the second part may be equal to N, or the sum of the first part and the second part may be less than N. How pixels that receive the first reset voltage and pixels that receive the second reset voltage in the N rows of pixels are arranged is not limited in embodiments of this application.

In the display 10 provided in this embodiment of this application, the reset voltage end provides the first reset voltage in the first time period in one image frame, and provides the second reset voltage in the second time period in the image frame. In addition, the value of the first reset voltage is different from the value of the second reset voltage. In this case, the first part of rows of pixels in the display 10 receive the first reset voltage, and the second part of rows of pixels receive the second reset voltage. When the reset voltage is fixed, factors such as unfixed load, unfixed frame rate, and voltage fluctuation cause uneven display brightness. In this embodiment of this application, a variable reset voltage is provided for the N rows of pixel circuits in one image frame, to reversely compensate for impact caused by the unfixed load, the unfixed frame rate, and the voltage fluctuation, so as to resolve a problem of uneven display brightness. In addition, the value of the reset voltage may be dynamically adjusted based on a position of a pixel row in the display 10. A row on which the first reset voltage is received and a row on which the second reset voltage is received may be dynamically adjusted. The first reset voltage may be received on spaced pixel rows in a plurality of areas, and the second reset voltage may be received on spaced pixel rows in a plurality of areas. An adjustment manner is dynamic, flexible, and applicable to a plurality of scenarios, and has a wide application range.

Light emitting brightness of the pixel circuit 11 is related to a magnitude of a drive current I. I=α·(V_{N1}−ELVDD+Vth)². Herein, a is a constant, and is related to a width-to-length ratio and mobility of the driving transistor T1. After the driving transistor T1 in the pixel circuit 11 is determined, α is a fixed value. V_{N1} is a voltage of the first node N1, and Vth is a threshold voltage of the driving transistor T1.

The voltage V_{N1} of the first node N1 is obtained by charging the driving transistor T1 by the data voltage end Vdata in the data writing and compensation phase t2, which is equivalent to charging in a resistor-capacitor (RC) circuit. In one row time, a lower initial voltage of the first node N1 indicates a lower voltage V_{N1} of the first node N1 obtained after charging ends. It can be learned from the formula of the drive current I that a lower voltage V_{N1} of the first node N1 indicates a greater absolute value of the voltage V_{N1} of the first node N1, a greater drive current I, and higher light emitting brightness of the light emitting device 116. On the contrary, a higher voltage V_{N1} of the first node N1 indicates a smaller drive current I and lower light emitting brightness of the light emitting device 116. Therefore, the light emitting brightness of the light emitting device 116 may be adjusted by adjusting the initial voltage of the first node N1. The initial voltage of the first node N1 may be adjusted by using a reset voltage of the first reset voltage end Vrefl.

The threshold voltage Vth of the driving transistor T1 is obtained by performing threshold voltage compensation on the driving transistor T1 by the data voltage end Vdata in the data writing and compensation phase t2. In one row time, a higher voltage of the second node N2 indicates a greater absolute value of the threshold voltage Vth of the driving transistor T1 obtained after compensation, a greater drive current I, and higher light emitting brightness of the light emitting device 116. Therefore, the light emitting brightness of the light emitting device 116 may be adjusted by adjusting the voltage of the second node N2. The voltage of the second node N2 may be adjusted by using a reset voltage of the second reset voltage end Vref2.

In addition, the light emitting brightness of the light emitting device 116 is in direct proportion to light emitting duration of the light emitting device 116, and the light emitting duration of the light emitting device 116 is related to both an initial voltage of the anode of the light emitting device 116 and the drive current I. A light emitting principle of the light emitting device 116 is as follows: When a voltage difference between the anode and a cathode of the light emitting device 116 is greater than a specified value, the light emitting device 116 starts to emit light. The drive circuit charges the anode of the light emitting device 116, and the light emitting device 116 starts to emit light after a voltage of the anode of the light emitting device 116 reaches a preset value through charging. The magnitude of the drive circuit I affects a speed at which the voltage of the anode reaches the preset value through charging, and the initial voltage of the anode also affects the speed at which the voltage of the anode reaches the preset value through charging. For example, when charging speeds are the same, if an initial voltage is small, time required for charging to the preset value is long. In this case, the light emitting duration is decreased, and the light emitting brightness of the light emitting device 116 is decreased. If the initial voltage is large, time required for charging to the preset value is short. In this case, the light emitting duration is increased, which is equivalent to increasing a duty cycle of the light emitting device 116, and the light emitting brightness of the light emitting device 116 is increased. Therefore, the light emitting brightness of the light emitting device 116 may be adjusted by adjusting the initial voltage of the anode of the light emitting device 116. The initial voltage of the anode of the light emitting device 116 may be adjusted by using a reset voltage of the third reset voltage end Vref3.

In conclusion, the light emitting brightness of the light emitting device 116 may be adjusted by adjusting the voltage of the first node N1, adjusting the voltage of the second node N2, and adjusting the voltage of the anode of the light emitting device 116.

In view of this, in some embodiments, as shown in FIG. 2, the plurality of reset voltage ends in the display 10 include the first reset voltage end Vref1, and the pixel circuit 11 includes the first reset circuit 111.

Two ends of the first reset circuit 111 are electrically connected to the control electrode of the driving transistor T1 and the first reset voltage end Vrefl respectively. Under control of the first control signal end P1, the reset voltage of the first reset voltage end Vrefl is transmitted to the control electrode (the first node N1) of the driving transistor T1 through the first reset circuit 111, to initialize and reset the control electrode of the driving transistor T1. The drive current of the pixel circuit 11 may be adjusted by adjusting the reset voltage of the first reset voltage end Vref1, to adjust light emitting brightness of the pixel circuit 11.

In some other embodiments, as shown in FIG. 2, the plurality of reset voltage ends in the display 10 include the second reset voltage end Vref2, and the pixel circuit 11 includes the driving transistor T1 and the second reset circuit 112.

Two ends of the second reset circuit 112 are electrically connected to the first electrode (the source or the drain) of the driving transistor T1 and the second reset voltage end Vref2 respectively. Under control of the second control signal end P2, the reset voltage of the second reset voltage end Vref2 is transmitted to the first electrode (the second node N2) of the driving transistor T1 through the second reset circuit 112, to initialize and reset the first electrode of the driving transistor T1. The drive current of the pixel circuit 11 may be adjusted by adjusting the reset voltage of the second reset voltage end Vref2, to adjust light emitting brightness of the pixel circuit 11.

In some other embodiments, as shown in FIG. 2, the plurality of reset voltage ends in the display 10 include the third reset voltage end Vref3, and the pixel circuit 11 includes the light emitting device 116 and the third reset circuit 113.

Two ends of the third reset circuit 113 are electrically connected to the anode of the light emitting device 116 and the third reset voltage end Vref3 respectively. Under control of the third control signal end P3, the reset voltage of the third reset voltage end Vref3 is transmitted to the anode of the light emitting device 116 through the third reset circuit 113, to initialize and reset the anode of the light emitting device 116. Light emitting duration of the pixel circuit 11 may be adjusted by adjusting the reset voltage of the third reset voltage end Vref3, to adjust light emitting brightness of the pixel circuit 11.

In some embodiments, the first reset voltage end Vrefl is configured to: provide the first reset voltage for a 1^{st} row to an M^{th} row of pixels, provide the second reset voltage for an (M+1)^{th} row to an I^{th} row of pixels, and provide the first reset voltage for an (I+1)^{th} row to an N^{th} row of pixels.

In some embodiments, the second reset voltage end Vref2 is configured to: provide the first reset voltage for a 1^{st} row to an M^{th} row of pixels, provide the second reset voltage for an (M+1)^{th} row to an I^{th} row of pixels, and provide the first reset voltage for an (I+1)^{th} row to an N^{th} row of pixels.

In some embodiments, the third reset voltage end Vrefl is configured to: provide the first reset voltage for a 1^{st} row to an M^{th} row of pixels, provide the second reset voltage for an (M+1)^{th} row to an I^{th} row of pixels, and provide the first reset voltage for an (I+1)^{th} row to an N^{th} row of pixels.

Certainly, a value of the first reset voltage provided by the first reset voltage end Vref1, a value of the first reset voltage provided by the second reset voltage end Vref2, and a value of the first reset voltage provided by the third reset voltage end Vref3 are not limited to being the same, and a value of the second reset voltage provided by the first reset voltage end Vref1, a value of the second reset voltage provided by the second reset voltage end Vref2, and a value of the second reset voltage provided by the third reset voltage end Vref3 are not limited to being the same, which are related to a value of a reset voltage actually required by the pixel circuit 11.

In addition, a first time period in which the first reset voltage end Vrefl provides the first reset voltage, a first time period in which the second reset voltage end Vref2 provides the first reset voltage, and a first time period in which the third reset voltage end Vref3 provides the first reset voltage are not limited to being the same, and a second time period in which the first reset voltage end Vrefl provides the second reset voltage, a second time period in which the second reset voltage end Vref2 provides the second reset voltage, and a second time period in which the third reset voltage end Vref3 provides the second reset voltage are not limited to being the same, which are related to a driving phase of the pixel circuit 11 in one image frame.

In a first application scenario, display brightness is uneven due to uneven arrangement of pixel circuits 11 in areas of the display 10, for example, a display like a punch-hole screen, a notch screen, a multi-hole screen, or a pill screen.

In some embodiments, the first reset voltage end Vrefl transmits the first reset voltage to evenly arranged areas, and transmits the second reset voltage to unevenly arranged areas.

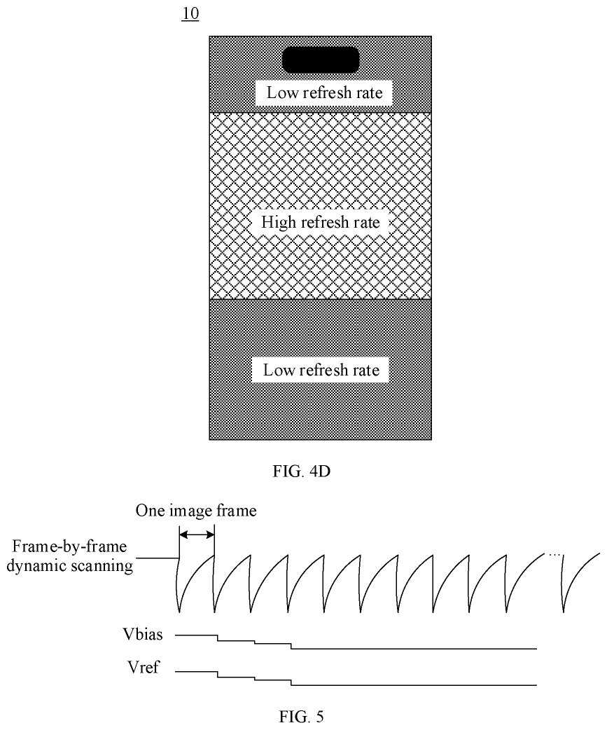

As shown in FIG. 6, the first reset voltage is used as a basic voltage. In one image frame, when the display 10 scans and activates a non-special area (the 1^{st} row to the M^{th} row) shown in FIG. 4C, the first reset voltage end Vrefl outputs the first reset voltage. When the display 10 scans and activates a special area (the (M+1)^{th} row to the I^{th} row) shown in FIG. 4C, the display 10 determines, based on a brightness difference between a pixel circuit 11 in the special area and a pixel circuit 11 in the non-special area, whether to increase or decrease the reset voltage based on the first reset voltage (determine a compensation voltage). In this case, the second reset voltage output by the first reset voltage end Vrefl is an adjusted reset voltage. For example, if brightness of the pixel circuit 11 in the special area needs to be increased, the reset voltage needs to be decreased based on the first reset voltage. If brightness of the pixel circuit 11 in the special area needs to be decreased, the reset voltage needs to be increased based on the first reset voltage. After the display 10 completes scanning of the special area (enters the (I+1)^{th} row), the first reset voltage end Vrefl outputs the first reset voltage again.

Certainly, in some other embodiments, the second reset voltage is used as a basic voltage. In one image frame, when the display 10 scans and activates the non-special area (the 1^{st} row to the M^{th} row) shown in FIG. 4C, the display 10 determines, based on a brightness difference between a pixel circuit 11 in the special area and a pixel circuit 11 in the non-special area, whether to increase or decrease the reset voltage based on the second reset voltage (determine a compensation voltage). In this case, the first reset voltage output by the first reset voltage end Vref1 is an adjusted reset voltage. For example, if brightness of the pixel circuit 11 in the non-special area needs to be increased, the reset voltage needs to be decreased based on the second reset voltage. If brightness of the pixel circuit 11 in the special area needs to be decreased, the reset voltage needs to be increased based on the second reset voltage. When the display 10 scans and activates the special area (the (M+1)^{th} row to the I^{th} row) shown in FIG. 4C, the first reset voltage end Vref1 outputs the second reset voltage. After the display 10 completes scanning of the special area (enters the (I+1)^{th} row), the first reset voltage end Vrefl outputs the first reset voltage again.

It should be noted herein that, in this embodiment of this application, an example in which display brightness of non-special areas on an upper side and a lower side of the special area is the same is used for illustration. Therefore, the non-special areas on the upper side and the lower side of the special area each receive the first reset voltage of the first reset voltage end Vref1. If the display brightness of the non-special areas on the upper side and the lower side of the special area is different, values of reset voltages of the first reset voltage end Vref1 received in the non-special areas on the upper side and the lower side of the special area may also be different, but a reset voltage adjustment principle remains unchanged. That is, if the brightness of the pixel circuit 11 needs to be increased, the reset voltage needs to be decreased based on a specified basic voltage. If the brightness of the pixel circuit 11 needs to be decreased, the reset voltage needs to be increased based on the specified basic voltage.

In this embodiment of this application, a value of M may be 0 or a positive integer, values of I and N are both positive integers, and M<I<N. Certainly, the values of M, I, and N are not limited in this embodiment of this application, and may be set with reference to a product.

The display 10 provided in this embodiment of this application is used to resolve uneven display brightness caused by uneven arrangement of the pixel circuits 11. When supplying power to the plurality of rows of pixel circuits 11, the first reset voltage end Vrefl provides the first reset voltage for an area in which pixel circuits 11 are evenly arranged, and provides the second reset voltage for a special area in which pixel circuits 11 are unevenly arranged, to perform reset voltage compensation for either the area in which the pixel circuits 11 are unevenly arranged or the area in which the pixel circuits 11 are evenly arranged, to implement brightness compensation for areas with different arrangement rules, so as to resolve a problem of uneven display brightness.

In some embodiments, the second reset voltage end Vref2 transmits the first reset voltage to evenly arranged areas, and transmits the second reset voltage to unevenly arranged areas. A switching principle of the reset voltage is the same as a switching principle of the first reset voltage and the second reset voltage of the first reset voltage end Vref1. Details are not described herein again.

In some embodiments, the third reset voltage end Vref3 transmits the first reset voltage to evenly arranged areas, and transmits the second reset voltage to unevenly arranged areas. A switching principle of the reset voltage is the same as a switching principle of the first reset voltage and the second reset voltage of the first reset voltage end Vref1. Details are not described herein again.

In a second application scenario, uneven display brightness is caused by different refresh rates of areas in the display 10.

In some embodiments, the first reset voltage end Vrefl transmits the first reset voltage to a low refresh rate area, and transmits the second reset voltage to a high refresh rate area.

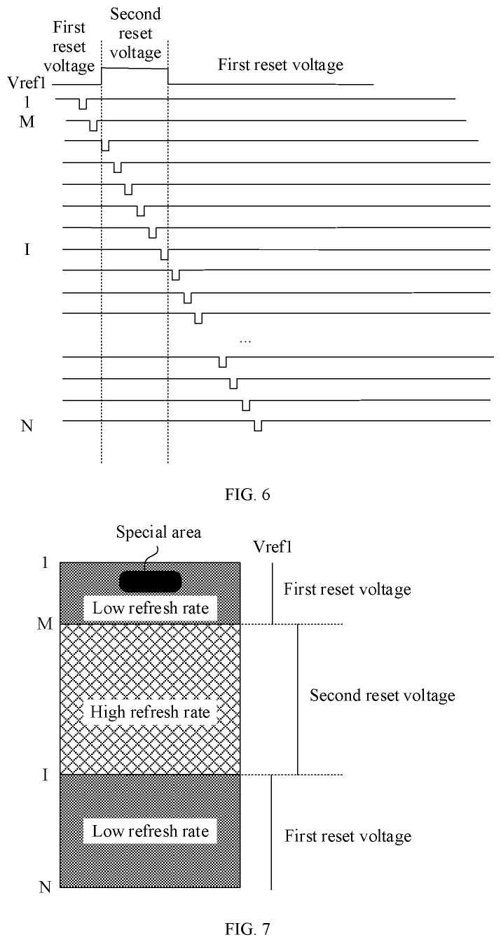

As shown in FIG. 7, the first reset voltage is used as a basic voltage. In one image frame, when the display 10 scans and activates a low refresh rate area (the 1^{st} row to the M^{th} row) shown in FIG. 7, the first reset voltage end Vref1 outputs the first reset voltage. When the display 10 scans and activates a high refresh rate area (the (M+1)^{th} row to the I^{th} row) shown in FIG. 7, the display 10 determines, based on a brightness difference between a pixel circuit 11 in the low refresh rate area and a pixel circuit 11 in the high refresh rate area, whether to increase or decrease the reset voltage based on the first reset voltage (determine a compensation voltage). In this case, the second reset voltage output by the first reset voltage end Vref1 is an adjusted reset voltage. For example, if brightness of the pixel circuit 11 in the high refresh rate area needs to be increased, the reset voltage needs to be decreased based on the first reset voltage. If brightness of the pixel circuit 11 in the high refresh rate area needs to be decreased, the reset voltage needs to be increased based on the first reset voltage. After scanning the high refresh rate area, the display 10 enters the low refresh rate area (enters the (I+1)^{th} row), the first reset voltage end Vref1 outputs the first reset voltage again.

Certainly, in some other embodiments, the second reset voltage is used as a basic voltage. In one image frame, when the display 10 scans and activates the low refresh rate area (the 1^{st} row to the M^{th} row) shown in FIG. 4D, the display 10 determines, based on a brightness difference between a pixel circuit 11 in the low refresh rate area and a pixel circuit 11 in the high refresh rate area, whether to increase or decrease the reset voltage based on the second reset voltage (determine a compensation voltage). In this case, the first reset voltage output by the first reset voltage end Vref1 is an adjusted reset voltage. For example, if brightness of the pixel circuit 11 in the low refresh rate area needs to be increased, the reset voltage needs to be decreased based on the second reset voltage. If brightness of the pixel circuit 11 in the low refresh rate area needs to be decreased, the reset voltage needs to be increased based on the second reset voltage. When the display 10 scans and activates the high refresh rate area (the (M+1)^{th} row to the I^{th} row) shown in FIG. 4D, the first reset voltage end Vref1 outputs the second reset voltage. After completes scanning of the high refresh rate area, the display 10 enters the low refresh rate area (enters the (I+1)^{th} row), the first reset voltage end Vref1 outputs the first reset voltage again.

It should be noted herein that, in this embodiment of this application, an example in which display brightness of low refresh rate areas on an upper side and a lower side of the high refresh rate area is the same is used for illustration. Therefore, the low refresh rate areas on the upper side and the lower side of the high refresh rate area each receive the first reset voltage of the first reset voltage end Vref1. If the display brightness of the low refresh rate areas on the upper side and the lower side of the ultra-high refresh rate area is different, values of reset voltages of the first reset voltage end Vref1 received in the low refresh rate areas on the upper side and the lower side of the high refresh rate area may also be different, but a reset voltage adjustment principle remains unchanged. That is, if the brightness of the pixel circuit 11 needs to be increased, the reset voltage needs to be decreased based on a specified basic voltage. If the brightness of the pixel circuit 11 needs to be decreased, the reset voltage needs to be increased based on the specified basic voltage.

In this embodiment of this application, a value of M may be 0 or a positive integer, values of I and N are both positive integers, and M<I<N. Certainly, the values of M, I, and N are not limited in this embodiment of this application, and may be set with reference to a product.

The display 10 provided in this embodiment of this application is used to resolve uneven display brightness caused by different refresh rates. When supplying power to the plurality of rows of pixel circuits 11, the first reset voltage end Vref1 provides the first reset voltage for the low refresh rate area, and provides the second reset voltage for the high refresh rate area, to perform reset voltage compensation for either the low refresh rate area or the high refresh rate area, to implement brightness compensation for areas with different refresh rates, so as to resolve a problem of uneven display brightness.

In some embodiments, the second reset voltage end Vref2 transmits the first reset voltage to a low refresh rate area, and transmits the second reset voltage to a high refresh rate area. A switching principle of the reset voltage is the same as a switching principle of the first reset voltage and the second reset voltage of the first reset voltage end Vref1. Details are not described herein again.

In some embodiments, the third reset voltage end Vref3 transmits the first reset voltage to a low refresh rate area, and transmits the second reset voltage to a high refresh rate area. A switching principle of the reset voltage is the same as a switching principle of the first reset voltage and the second reset voltage of the first reset voltage end Vref1. Details are not described herein again.

In a third application scenario, uneven display brightness is caused by uneven arrangement of pixel circuits 11 and different refresh rates of areas in the display 10.

In this case, the reset voltage output by the first reset voltage end Vref not only includes the first reset voltage and the second reset voltage, but may further include a third reset voltage or more reset voltages with different values.

As shown in FIG. 7, the special area is located in the low refresh rate area. In this case, when providing a reset voltage for a pixel row in the low refresh rate area, the first reset voltage end Vref1 may perform reset voltage compensation for the special area and the non-special area in the low refresh rate area with reference to the related descriptions in FIG. 6, to make display brightness in the low refresh rate area even.

It should be understood that, the structure shown in FIG. 7 is used as an example. If reset voltage compensation of the special area and the non-special area is combined with reset voltage compensation of the high refresh rate area and the low refresh rate area, values of M and I during division of the special area and the non-special area are different from values of M and I during division of the high refresh rate area and the low refresh rate area.

In this case, it may be equivalent to that the first reset voltage end Vref1 is configured to: provide the first reset voltage for the 1^{st} row to the M^{th} row of pixels (the non-special area in the low refresh rate area), provide the second reset voltage for the (M+1)^{th} row to the I^{th} row of pixels (the non-special area in the low refresh rate area), provide the first reset voltage for the (I+1)^{th} row to the Lth row of pixels (the non-special area in the low refresh rate area), provide the third reset voltage for the (L+1)^{th} row to the T^{th} row of pixels (the high refresh rate area), and provide the first reset voltage for the (T+1)^{th} row to the N^{th} row of pixels (the low refresh rate area).

In this embodiment of this application, a value of M may be 0 or a positive integer, values of I, L, T, and N are all positive integers, and M<I<L<T<N. Certainly, the values of M, I, L, T, and N are not limited in this embodiment of this application, and may be set with reference to a product.

In some embodiments, the second reset voltage end Vref2 transmits the first reset voltage to the non-special area in the low refresh rate area, transmits the second reset voltage to the non-special area in the low refresh rate area, transmits the first reset voltage to the non-special area in the low refresh rate area, transmits the third reset voltage to the high refresh rate area, and transmits the first reset voltage to the low refresh rate area. A switching principle of the reset voltage is the same as a switching principle of the first reset voltage, the second reset voltage, and the third reset voltage of the first reset voltage end Vref1. Details are not described herein again.

In some embodiments, the third reset voltage end Vref3 transmits the first reset voltage to the non-special area in the low refresh rate area, transmits the second reset voltage to the non-special area in the low refresh rate area, transmits the first reset voltage to the non-special area in the low refresh rate area, transmits the third reset voltage to the high refresh rate area, and transmits the first reset voltage to the low refresh rate area. A switching principle of the reset voltage is the same as a switching principle of the first reset voltage, the second reset voltage, and the third reset voltage of the first reset voltage end Vref1. Details are not described herein again.

The display 10 provided in this embodiment of this application is used to resolve uneven display brightness caused by uneven arrangement of pixel circuits 11 and different refresh rates. When supplying power to the plurality of rows of pixel circuits 11, the first reset voltage end Vref1 provides the first reset voltage for the low refresh rate area, and provides the second reset voltage for the high refresh rate area, to perform reset voltage compensation for either the low refresh rate area or the high refresh rate area, to implement brightness compensation for areas with different refresh rates, so as to resolve a problem of uneven display brightness.

In a fourth application scenario, uneven display brightness is caused by a reset voltage fluctuation.

In some embodiments, the first reset voltage end Vref1 is configured to: provide the first reset voltage for the 1^{st} row to the M^{th} row of pixels (a bright band area), provide the second reset voltage for the (M+1)^{th} row to the I^{th} row of pixels (a dark band area), provide the first reset voltage for the (I+1)^{th} row to the Lth row of pixels (a bright band area), provide the second reset voltage for the (L+1)^{th} row to the T^{th} row of pixels (a dark band area), and provide the first reset voltage for the (T+1)^{th} row to the N^{th} row of pixels (a bright band area).

Certainly, in this embodiment of this application, an example in which display brightness of a plurality of bright band areas in the display 10 is the same is merely used for illustration. If the display brightness of the plurality of bright band areas is different, reset voltages output by the first reset voltage end Vref1 to the plurality of bright band areas are also different. Similarly, an example in which display brightness of a plurality of dark band areas in the display 10 is the same is used for illustration. If the display brightness of the plurality of dark band areas is different, reset voltages output by the first reset voltage end Vref1 to the plurality of dark band areas are also different.

In some embodiments, the second reset voltage end Vref2 is configured to: provide the first reset voltage for the 1^{st} row to the M^{th} row of pixels (a bright band area), provide the second reset voltage for the (M+1)^{th} row to the I^{th} row of pixels (a dark band area), provide the first reset voltage for the (I+1)^{th} row to the Lth row of pixels (a bright band area), provide the second reset voltage for the (L+1)^{th} row to the T^{th} row of pixels (a dark band area), and provide the first reset voltage for the (T+1)^{th} row to the N^{th} row of pixels (a bright band area).

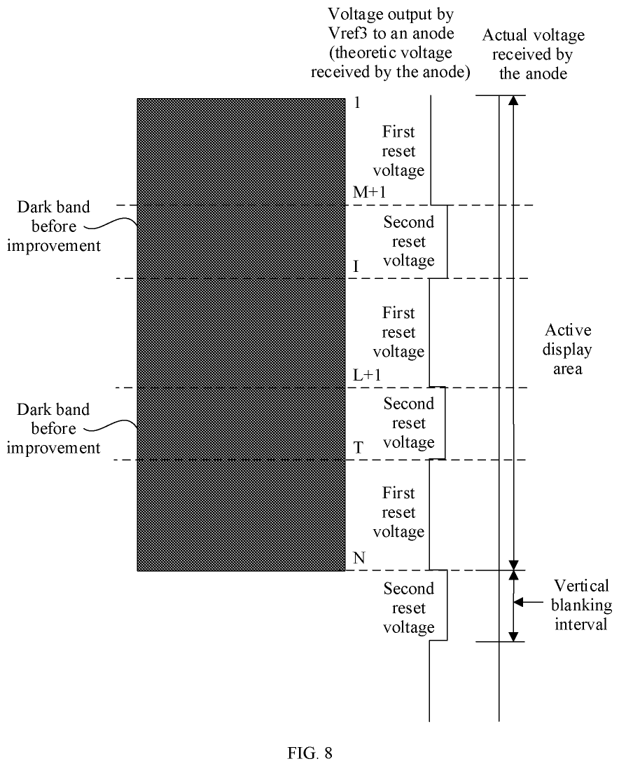

In some embodiments, as shown in FIG. 8, the third reset voltage end Vref3 is configured to: provide the first reset voltage for the 1^{st} row to the M^{th} row of pixels (a bright band area), provide the second reset voltage for the (M+1)^{th} row to the I^{th} row of pixels (a dark band area), provide the first reset voltage for the (I+1)^{th} row to the Lth row of pixels (a bright band area), provide the second reset voltage for the (L+1)^{th} row to the T^{th} row of pixels (a dark band area), and provide the first reset voltage for the (T+1)^{th} row to the N^{th} row of pixels (a bright band area).

In this embodiment of this application, a value of M may be 0 or a positive integer, values of I, L, T, and N are all positive integers, and M<I<L<T<N. Certainly, the values of M, I, L, T, and N are not limited in this embodiment of this application, and may be set with reference to a product.

Certainly, a value of the first reset voltage provided by the first reset voltage end Vref1, a value of the first reset voltage provided by the second reset voltage end Vref2, and a value of the first reset voltage provided by the third reset voltage end Vref3 are not limited to being the same, and a value of the second reset voltage provided by the first reset voltage end Vref1, a value of the second reset voltage provided by the second reset voltage end Vref2, and a value of the second reset voltage provided by the third reset voltage end Vref3 are not limited to being the same, which are related to a value of a reset voltage actually required by the pixel circuit 11.

In addition, a first time period in which the first reset voltage end Vref1 provides the first reset voltage, a first time period in which the second reset voltage end Vref2 provides the first reset voltage, and a first time period in which the third reset voltage end Vref3 provides the first reset voltage are not limited to being the same, and a second time period in which the first reset voltage end Vref1 provides the second reset voltage, a second time period in which the second reset voltage end Vref2 provides the second reset voltage, and a second time period in which the third reset voltage end Vref3 provides the second reset voltage are not limited to being the same, which are related to a driving phase of the pixel circuit 11 in one image frame.

In addition, in this embodiment of this application, a pixel row for receiving the first reset voltage provided by the first reset voltage end Vref1, a pixel row for receiving the first reset voltage provided by the second reset voltage end Vref2, and a pixel row for receiving the first reset voltage provided by the third reset voltage end Vref3 are not limited to being the same. The foregoing is merely an example. Similarly, in this embodiment of this application, a pixel row for receiving the second reset voltage provided by the first reset voltage end Vref1, a pixel row for receiving the second reset voltage provided by the second reset voltage end Vref2, and a pixel row for receiving the second reset voltage provided by the third reset voltage end Vref3 are not limited to being the same. The foregoing is merely an example.

The third reset voltage end Vref3 is used as an example. As shown in FIG. 8, the first reset voltage is used as a basic voltage. In one image frame, when the display 10 scans and activates a bright band area (the 1^{st} row to the M^{th} row) shown in FIG. 8, the third reset voltage end Vref3 outputs the first reset voltage. When the display 10 scans and activates a dark band area (the (M+1)^{th} row to the I^{th} row) shown in FIG. 8, the display 10 determines, based on a brightness difference between a pixel circuit 11 in the bright band area and a pixel circuit 11 in the dark band area, whether to increase or decrease the reset voltage based on the first reset voltage (determine a compensation voltage). In this case, the second reset voltage output by the third reset voltage end Vref3 is the adjusted reset voltage. For example, if brightness of the pixel circuit 11 in the dark band area needs to be increased, the reset voltage needs to be increased based on the first reset voltage. If brightness of the pixel circuit 11 in the dark band area needs to be decreased, the reset voltage needs to be decreased based on the first reset voltage. After scanning the dark band area, the display 10 re-scans and enters the bright band area (enters the (I+1)^{th} row to the Lth row), and the third reset voltage end Vref3 outputs the first reset voltage again. When the display 10 re-scans and enters the dark band area (enters the (L+1)^{th} row to the T^{th} row), the third reset voltage end Vref3 outputs the second reset voltage again. When the display 10 re-scans and enters the bright band area (enters the (L+1)^{th} row to the N^{th} row), the third reset voltage end Vref3 outputs the first reset voltage again.

The third reset voltage end Vref3 may perform compensation at a reset voltage fluctuation position, and exit compensation after the fluctuation ends. Each time the reset voltage fluctuates at one position, the reset voltage output by the third reset voltage end Vref3 is compensated for once. Certainly, compensation values at different fluctuation positions may be different. This is not limited in embodiments of this application. In this embodiment of this application, only an example in which the reset voltage fluctuates three times and compensation values are the same each time is used for description.

Alternatively, the second reset voltage is a basic voltage. In one image frame, when the display 10 scans and activates the bright band area (the 1^{st} row to the M^{th} row) shown in FIG. 8, the display 10 determines, based on a brightness difference between a pixel circuit 11 in the bright band area and a pixel circuit 11 in the dark band area, whether to increase or decrease the reset voltage based on the second reset voltage (determine a compensation voltage). In this case, the first reset voltage output by the third reset voltage end Vref3 is the adjusted reset voltage. For example, if brightness of the pixel circuit 11 in the bright band area needs to be increased, the reset voltage needs to be increased based on the second reset voltage. If brightness of the pixel circuit 11 in the bright band area needs to be decreased, the reset voltage needs to be decreased based on the second reset voltage. When the display 10 scans and activates the dark band area (the (M+1)^{th} row to the I^{th} row) shown in FIG. 8, the third reset voltage end Vref3 outputs the second reset voltage. When the display 10 re-scans and enters the bright band area (enters the (I+1)^{th} row to the Lth row), the third reset voltage end Vref3 outputs the first reset voltage again. When the display 10 re-scans and enters the dark band area (enters the (L+1)^{th} row to the T^{th} row), the third reset voltage end Vref3 outputs the second reset voltage again. When the display 10 re-scans and enters the bright band area (enters the (L+1)^{th} row to the N^{th} row), the third reset voltage end Vref3 outputs the first reset voltage again.

As shown in FIG. 8, the reset voltage output by the third reset voltage end Vref3 is adjusted, so that after the third reset voltage end Vref3 bears a load fluctuation, reset voltages actually received by anodes of the plurality of rows of pixel circuits 11 are equal. This resolves a problem of uneven display brightness caused by a reset voltage fluctuation.

Certainly, the third application scenario and the fourth application scenario may be considered together. In this case, when transmitting reset voltages, the first reset voltage end Vref1, the second reset voltage end Vref2, and the third reset voltage end Vref3 comprehensively consider cases in the third application scenario and the fourth application scenario.

An embodiment of this application further provides a display driver 20, including an image data receiving end, a processing circuit, and a plurality of reset voltage output ends.

The image data receiving end is configured to receive image data. The image data may be, for example, provided by a system on chip (system on chip, SOC) of an electronic device.

The processing circuit is configured to generate a first reset voltage and a second reset voltage based on the image data. A value of the first reset voltage is different from a value of the second reset voltage. For the values of the first reset voltage and the second reset voltage, refer to the foregoing related descriptions of the display 10 and the display driver 20.

The plurality of reset voltage output ends include at least one reset voltage output end configured to: output the first reset voltage in a first time period in one image frame, and output the second reset voltage in a second time period in the image frame.

Certainly, the processing circuit may output one group of a first reset voltage and a second reset voltage, or may output a plurality of groups of first reset voltages and second reset voltages. However, a first reset voltage and a second reset voltage in a same group are output from a same reset voltage output end.

In some embodiments, the display driver 20 further includes a temperature receiving end, and the temperature receiving end is configured to receive temperature data. The processing circuit is configured to generate the first reset voltage and the second reset voltage with reference to the temperature data and the image data. The temperature data may be provided by a temperature sensor in the electronic device.

A temperature of the display 10 affects component performance of the pixel circuit 11 in the display 10. Therefore, a temperature of the display 10 is also considered as a factor for adjusting a reset voltage value, so that uniformity of display brightness can be further improved.

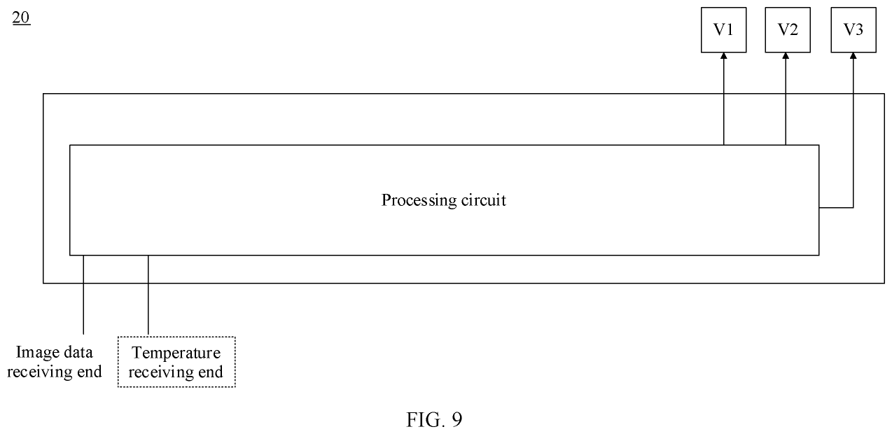

FIG. 9 is a diagram of a structure of a display driver according to an embodiment of this application.

As shown in FIG. 9, in some embodiments, the display 10 includes the first reset voltage end Vref1, the display driver 20 includes the first reset voltage output end V1, and the first reset voltage output end V1 is configured to be coupled to the first reset voltage end Vref1 to output the first reset voltage and the second reset voltage to the first reset voltage end Vref1.

In some embodiments, the display 10 includes the second reset voltage end Vref2, the display driver 20 includes the second reset voltage output end V2, and the second reset voltage output end V2 is configured to be coupled to the second reset voltage end Vref2 to output the first reset voltage and the second reset voltage to the second reset voltage end Vref2.

In some embodiments, the display 10 includes the third reset voltage end Vref3, the display driver 20 includes the third reset voltage output end V3, and the third reset voltage output end V3 is configured to be coupled to the third reset voltage end Vref3 to output the first reset voltage and the second reset voltage to the third reset voltage end Vref3.

In some embodiments, as shown in FIG. 9, the display driver 20 includes a voltage calculation module 21, a voltage time sequence control module 22, and a voltage output module 23.

The voltage calculation module 21 is configured to: receive image data, and output a basic voltage and a compensation voltage. A grayscale signal (R/G/B), a display brightness value (display brightness value, DBV) signal, and a frame rate signal may be obtained from the image data. The voltage calculation module 21 may calculate a basic voltage and a compensation voltage in reset voltages of the first reset voltage end Vref1, the second reset voltage end Vref2, and the third reset voltage end Vref3 by using the grayscale signal, the display brightness signal, and the frame rate signal. The voltage calculation module 21 may directly receive the image data, or another module may receive the image data, and then transmit a processing result to the voltage calculation module 21.

The voltage time sequence control module 22 is configured to: receive the basic voltage, the compensation voltage, and a row signal, and output the first reset voltage or the second reset voltage and a trigger signal. The row signal includes information such as a currently scanned row, rows that need to output basic voltages, and rows that need to output adjusted voltages. The voltage time sequence control module 22 determines, based on the row signal, whether to output the basic voltage or output a sum of the basic voltage and the compensation voltage. One of a sum of basic voltages and the sum of the basic voltage and the compensation voltage is used as the first reset voltage, and the other is used as the second reset voltage. The voltage time sequence control module 22 outputs the first reset voltage or the second reset voltage, and outputs the trigger signal at the same time.

The voltage output module 23 is configured to: receive the trigger signal, the first reset voltage, and the second reset voltage, and output the first reset voltage or the second reset voltage. After receiving the trigger signal, the voltage output module 23 determines that a current reset voltage is a valid output voltage, and receives the first reset voltage or the second reset voltage. It should be understood that the voltage output module 23 may receive and output the first reset voltage and the second reset voltage at different moments, but can receive and output either the first reset voltage or the second reset voltage at a same moment.

When the display driver 20 further includes the first reset voltage output end V1, the second reset voltage output end V2, and the third reset voltage output end V3. If the display driver 20 includes only one group of a voltage calculation module 21, a voltage time sequence control module 22, and a voltage output module 23, the display driver 20 may sequentially output reset voltages from the first reset voltage output end V1, the second reset voltage output end V2, and the third reset voltage output end V3. If the display driver 20 includes three groups of voltage calculation modules 21, voltage time sequence control modules 22, and voltage output modules 23, the display driver 20 outputs a reset voltage to one reset voltage output end in each group, and the display driver 20 may simultaneously output reset voltages from the first reset voltage output end V1, the second reset voltage output end V2, and the third reset voltage output end V3.

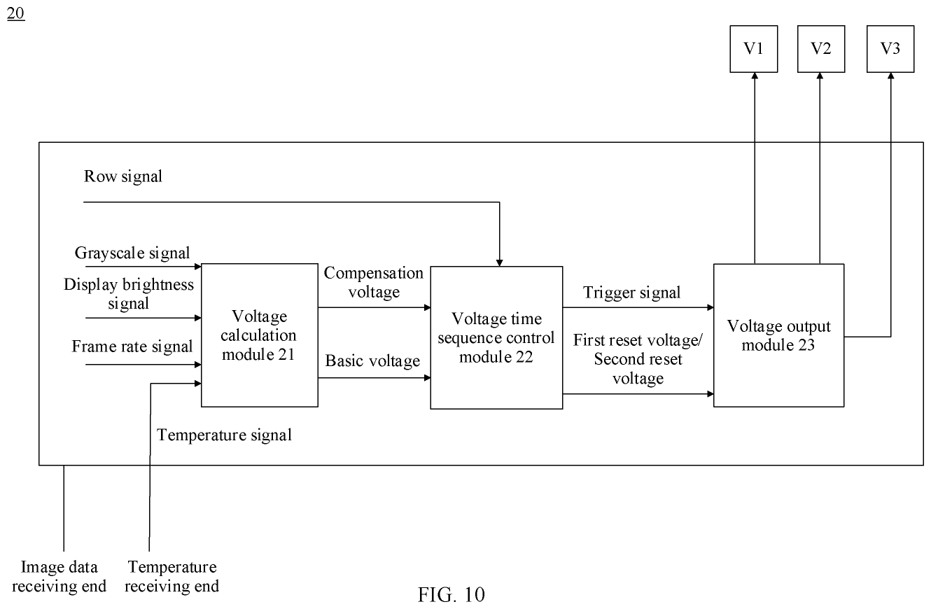

FIG. 10 is a diagram of a structure of a display driver according to an embodiment of this application.

In some embodiments, as shown in FIG. 10, the voltage calculation module 21 is further configured to receive a frame rate signal.

For example, in the foregoing second application scenario, a value of the reset voltage is also related to frame rate information of the high refresh rate area and the low refresh rate area. In this case, the voltage calculation module 21 may receive the frame rate signal to calculate a basic voltage and a compensation voltage.

The display driver 20 provided in this embodiment of this application may dynamically adjust the reset voltage based on a grayscale signal, a display brightness signal, a temperature signal, and the frame rate signal, so that the plurality of rows of pixel circuits 11 of the display 10 receive dynamically adjustable reset voltages. This can effectively resolve a problem of a brightness difference like a horizontal bright band and dark band in a display process, and improve display consistency.

An embodiment of this application further provides an electronic device, including any one of the foregoing displays 10 and any one of the foregoing display drivers 20. A driving method of the electronic device includes:
in one image frame, activating N rows of pixels of the display 10 row by row. Activating the pixels may be understood as that the N rows of pixels perform the initialization phase t1, the data writing and compensation phase t2, the light emitting phase t3, and the anode reset phase t row by row. A gate on array of the display 10 outputs an activating signal to the pixel circuit 11 row by row.

The reset voltage output end of the display driver 20 outputs a first reset voltage to the display 10 in a first time period, and a first part of the N rows of pixels receives the first reset voltage for reset. The reset voltage output end outputs a second reset voltage to the display 10 in a second time period, and a second part of the N rows of pixels receives the second reset voltage for reset. For a case of the first reset voltage and the second reset voltage output by the display driver 20, refer to the foregoing related descriptions about the display driver 20 and the display 10. Details are not described herein again.

For example, in the foregoing first or second application scenario, when the 1^{st} row of pixels is activated, the reset voltage output end (for example, the first reset voltage output end V1) outputs the first reset voltage to the reset voltage end (for example, the first reset voltage end Vref1) of the display 10.

When the (M+1)^{th} row of pixels is activated, the reset voltage output end (for example, the first reset voltage output end V1) outputs the second reset voltage to the reset voltage end (for example, the first reset voltage end Vref1) of the display 10.

When the (I+1)^{th} row of pixels is activated, the reset voltage output end (for example, the first reset voltage output end V1) outputs the first reset voltage to the reset voltage end (for example, the first reset voltage end Vref1) of the display 10.

Alternatively, for example, in the foregoing third application scenario, when the 1^{st} row of pixels is activated, the reset voltage output end (for example, the first reset voltage output end V1) outputs the first reset voltage to the reset voltage end (for example, the first reset voltage end Vref1) of the display 10.

When the (M+1)^{th} row of pixels is activated, the reset voltage output end (for example, the first reset voltage output end V1) outputs the second reset voltage to the reset voltage end (for example, the first reset voltage end Vref1) of the display 10.

When the (I+1)^{th} row of pixels is activated, the reset voltage output end (for example, the first reset voltage output end V1) outputs a third reset voltage to the reset voltage end (for example, the first reset voltage end Vref1) of the display 10.

When the (L+1)^{th} row of pixels is activated, the reset voltage output end (for example, the first reset voltage output end V1) outputs the first reset voltage to the reset voltage end (for example, the first reset voltage end Vref1) of the display 10.

Alternatively, for example, in the foregoing fourth application scenario, when the 1^{st} row of pixels is activated, the reset voltage output end (for example, the third reset voltage output end V3) outputs the first reset voltage to the reset voltage end (for example, the third reset voltage end Vref3) of the display 10.

When the (M+1)^{th} row of pixels is activated, the reset voltage output end (for example, the third reset voltage output end V3) outputs the second reset voltage to the reset voltage end (for example, the third reset voltage end Vref3) of the display 10.

When the (I+1)^{th} row of pixels is activated, the reset voltage output end (for example, the third reset voltage output end V3) outputs the second reset voltage to the reset voltage end (for example, the third reset voltage end Vref3) of the display 10.

When the (L+1)^{th} row of pixels is activated, the reset voltage output end (for example, the third reset voltage output end V3) outputs the first reset voltage to the reset voltage end (for example, the third reset voltage end Vref3) of the display 10.

The foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

1. A display, comprising:
N rows of pixels, wherein each row of pixels comprises a plurality of pixel circuits spaced from each other, wherein N is a positive integer; and
a plurality of reset voltage ends, wherein each reset voltage end is electrically connected to the N rows of pixels, wherein
at least one of the plurality of reset voltage ends is configured to:
provide a first reset voltage to the plurality of pixel circuits in a first time period in an image frame, and
provide a second reset voltage to the plurality of pixel circuits in a second time period in the image frame, wherein a value of the first reset voltage is different from a value of the second reset voltage.

2. The display according to claim 1, wherein a first part of the N rows of pixels is configured to receive the first reset voltage in the first time period, and a second part of the N rows of pixels is configured to receive the second reset voltage in the second time period.

3. The display according to claim 1, wherein the plurality of reset voltage ends comprise a first reset voltage end, and one of the plurality of pixel circuits comprises a driving transistor and a first reset circuit; and
wherein two ends of the first reset circuit are electrically connected to a control electrode of the driving transistor and the first reset voltage end respectively.

4. The display according to claim 1, wherein the plurality of reset voltage ends comprise a second reset voltage end, and one of the plurality of pixel circuits comprises a driving transistor and a second reset circuit; and
wherein two ends of the second reset circuit are electrically connected to a first electrode of the driving transistor and the second reset voltage end respectively.

5. The display according to claim 1, wherein the plurality of reset voltage ends comprise a third reset voltage end, and one of the plurality of pixel circuits comprises a light emitting device and a third reset circuit; and
wherein two ends of the third reset circuit are electrically connected to an anode of the light emitting device and the third reset voltage end respectively.

6. The display according to claim 1, wherein the at least one of the plurality of reset voltage ends is configured to:
provide the first reset voltage for a 1^{st} row to an M^{th} row of pixels,
provide the second reset voltage for an (M+1)^{th} row to an I^{th} row of pixels, and
provide the first reset voltage for an (I+1)^{th} row to an N^{th} row of pixels, wherein M<I<N.

7. The display according to claim 1, wherein the at least one of the plurality of reset voltage ends is configured to:
provide the first reset voltage for a 1^{st} row to an M^{th} row of pixels,
provide the second reset voltage for an (M+1)^{th} row to an I^{th} row of pixels,
provide the first reset voltage for an (I+1)^{th} row to an L^{th} row of pixels,
provide the second reset voltage or a third reset voltage for an (L+1)^{th} row to a T^{th} row of pixels, and
provide the first reset voltage for a (T+1)^{th} row to an N^{th} row of pixels, wherein M<I<L<T<N.

8. The display according to claim 5, wherein the plurality of reset voltage ends further comprise a first reset voltage end and a second reset voltage end, and wherein the value of the first reset voltage output by the first reset voltage end, the value of the first reset voltage output by the second reset voltage end, and the value of the first reset voltage output by the third reset voltage end are different.

9. A display driver, comprising:
an image data receiving end, configured to receive image data;
a processing circuit, configured to generate a first reset voltage and a second reset voltage based on the image data, wherein a value of the first reset voltage is different from a value of the second reset voltage; and
a plurality of reset voltage output ends, wherein at least one of the plurality of reset voltage output ends is configured to:
output the first reset voltage in a first time period in an image frame, and
output the second reset voltage in a second time period in the image frame.

10. The display driver according to claim 9, further comprising a temperature receiving end, configured to receive temperature data, wherein the processing circuit is further configured to generate the first reset voltage and the second reset voltage based on the temperature data.

11. The display driver according to claim 9, wherein the processing circuit further comprises:
a voltage calculation module, configured to:
receive the image data, and
output a basic voltage and a compensation voltage;
a voltage time sequence control module, configured to:
receive the basic voltage, the compensation voltage, and a row signal, and
output the first reset voltage or the second reset voltage and a trigger signal; and
a voltage output module, configured to:
receive the trigger signal, the first reset voltage, and the second reset voltage, and
output the first reset voltage or the second reset voltage.

12. The display driver according to claim 9, wherein the plurality of reset voltage output ends comprise a first reset voltage output end, a second reset voltage output end, and a third reset voltage output end; and
wherein the value of the first reset voltage output by the first reset voltage output end, the value of the first reset voltage output by the second reset voltage output end, and the value of the first reset voltage output by the third reset voltage output end are different.

13. An electronic device, comprising a display and a display driver, wherein the display comprises:
N rows of pixels, wherein each row of pixels comprises a plurality of pixel circuits spaced from each other, wherein N is a positive integer; and
a plurality of reset voltage ends, wherein each reset voltage end is electrically connected to the N rows of pixels, wherein
at least one of the plurality of reset voltage ends is configured to:
provide a first reset voltage to the plurality of pixel circuits in a first time period in an image frame, and
provide a second reset voltage to the plurality of pixel circuits in a second time period in the image frame, wherein a value of the first reset voltage is different from a value of the second reset voltage,
wherein the display driver comprises:
an image data receiving end, configured to receive image data;
a processing circuit, configured to generate the first reset voltage and the second reset voltage based on the image data; and
a plurality of reset voltage output ends, wherein at least one of the plurality of reset voltage output ends is configured to:
output the first reset voltage in a first time period in an image frame, and
output the second reset voltage in a second time period in the image frame; and
wherein the plurality of reset voltage ends of the display are electrically connected to the plurality of reset voltage output ends of the display driver.

14. A driving method of an electronic device comprising a display and a display driver, comprising:
in one image frame:
activating N rows of pixels of the display row by row, wherein N is a positive integer; and
outputting, by a reset voltage output end of the display driver, a first reset voltage to the display in a first time period; and outputting, by the reset voltage output end, a second reset voltage to the display in a second time period,
wherein a first part of the N rows of pixels receives the first reset voltage for reset, a second part of the N rows of pixels receives the second reset voltage for reset, and a value of the first reset voltage is different from a value of the second reset voltage.

15. The driving method of the electronic device according to claim 14, wherein:
in response to a 1^{st} row of pixels being activated, outputting, by the reset voltage output end, the first reset voltage to the display;
in response to an (M+1)^{th} row of pixels being activated, outputting, by the reset voltage output end, the second reset voltage to the display; and
in response to an (I+1)^{th} row of pixels being activated, outputting, by the reset voltage output end, the first reset voltage to the display, wherein M<I<N.

16. The driving method of the electronic device according to claim 14, wherein:
in response to a 1^{st} row of pixels being activated, outputting, by the reset voltage output end, the first reset voltage to the display;
in response to an (M+1)^{th} row of pixels being activated, outputting, by the reset voltage output end, the second reset voltage to the display;
in response to an (I+1)^{th} row of pixels being activated, outputting, by the reset voltage output end, the second reset voltage or a third reset voltage to the display; and
in response to an (L+1)^{th} row of pixels being activated, outputting, by the reset voltage output end, the first reset voltage to the display, wherein M<I<L<N.
